(19) United States
(12) Patent Application Publication
(10) Pub. No.: US 2009/0164520 A1
(43) Pub. Date: Jun. 25, 2009

(54) Deemed export - technology transfer manager

(76) Inventors: Michelle Schulz, Dallas, TX (US); Ralf Erich Schulz, San Francisco, CA (US)

Correspondence Address: Michelle Schulz, Suite 300, 6510 Abrams Road, Dallas, TX, 75231, US

(21) Appl. No.: 12/004,818

(22) Filed: Dec. 21, 2007

(51) Int. Cl. G06F 17/30

(52) U.S. Cl. 707/104.1

(57) ABSTRACT

In order to comply with the Export Administration Regulations (EAR) of a “deemed export” and the International Traffic in Arms Regulations (ITAR) of a “technology transfer,” the present invention provides a visible database tracking immigration status and product technology access from the time of potential hire until termination of an employee, determines foreign national status for deemed export purposes, tracks every product by part number and/or Export Commerce Control Number (ECCN) to which each foreign national has access, determines who needs an export license under the deemed export rule, provides a cross-reference with nationality and product, and provides audit reports, immigration status reports, and employee licensing breakdown, listing foreign employee with the type of technology accessed, visa information and export license information.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### COPYRIGHT NOTICE

A portion of the disclosure of this patent document contains or may contain material, which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### BACKGROUND OF THE INVENTION

1. Field of the Invention

Under the Export Administration Regulations (EAR), a “deemed export” is a transfer of data or technology to a foreign national in the United States. This same concept is called a “technology transfer” under the International Traffic in Arms Regulations (ITAR) and in the case of transfers to foreign nationals abroad. The Bureau of Industry and Security (BIS) controls EAR issues, and the Department of State controls ITAR issues. This invention provides a visible database tracking immigration status and product access from the time of hire until termination. All sites, foreign and abroad, enter their employees into the database at the time of hire or before. All sites enter products and technology into the database, if a foreign national has or could potentially have access to them. The user would be able to store documents on the site/program for subsequent access.

2. Description of the Prior Art

The U.S. Government and other governments maintain a number of complex export and technology transfer restrictions that subject companies to fines for failure to comply with the regulations. Usually, these fines occur because there is not in place any practical system for monitoring and compliance of EAR and ITAR.

2004/0117337 A1 describes a system and computer-based method for performing export compliance review of electronic documents. An electronic document is submitted for export compliance review to a server over a network. The server automatically reviews the submitted document according to predefined export compliance rules and automatically generates export compliance information based on the review. Final export compliance information for the submitted document is generated based on an export compliance officer's review of the automatically generated export compliance information with respect to the export compliance rules. The final export compliance information is stored with the submitted document.

An export compliance manager would like to be able to track every new hire's immigration status throughout their time at the company and would like to determine who is a “foreign national” for deemed export purposes. An export compliance manager would like to have a notification of possible non-compliance, if a person is a “foreign national” under the deemed export rule and would allow the determination of who is a “foreign national” for deemed export purposes.

An export compliance manager would like to be able to track every product, by part number and/or Export Commerce Control Number (ECCN), to which each foreign national has access and would allow the determination of who might need an export license under the deemed export rule. An export compliance manager would like to be able to track every foreign national abroad who has access to technical data and to which technical data they have access, and how is it controlled and how to monitor technology transfers abroad. An export compliance manager would like to have a notification every time an export license is required for a foreign national, as early as possible, even before hiring them and be able to file the required export license applications.

The rules for deemed exports under the Export Administration Regulations (EAR) are different from the rules for deemed exports under the International Traffic in Arms Regulations (ITAR). An export compliance manager would like to have separate notifications that would show which rules apply, which would allow the filing of the license application with the correct agency.

There exists a need for providing an export compliance and technology transfer program to match foreign nationals with product in compliance with the regulations under EAR and ITAR.

A company's export compliance manager manger needs to be able to track every new employee's immigration status throughout the employee's employment. The export compliance manager needs to determine who is a foreign national for deemed export purposes.

This invention provides a visible database tracking employee status from the initial time of employment until termination. This invention provides a determination of who is a foreign national for deemed export purposes. This invention tracks every product, by part number and/or Export Commerce Control Number (ECCN), to which each foreign national has access and determines who needs an export license under the deemed export rule. This invention provides a cross-reference with nationality and product.

### BRIEF SUMMARY OF THE INVENTION

The present invention relates to a visible database tracking employee status from the initial time of employment until termination. This invention provides a determination of who is a foreign national for deemed export purposes. This invention tracks every product, by part number and/or Export Commerce Control Number (ECCN), to which each foreign national has access and determines who needs an export license under the deemed export rule. This invention provides a cross-reference with nationality and product. This invention provides the upload of actual backup documents, such as a foreign national's passport or a product design in PDF format, onto the program and the user is able to store documents on the site/program for future retrieval.

This invention tracks every foreign national abroad who has access to technical data, to which technical data and how is it controlled and monitors technology transfers abroad. This invention would provide immediate notification of the requirement of filing an export license application for any foreign national before or after hiring the employee. Deemed exports rules under EAR are different from the rules for deemed exports under ITAR. Separate notifications under each set of rules allow the proper license application to be filed with the correct agency.

The invention accordingly comprises the features of a visible database tracking immigration status and product access from the time of hire until termination that is exemplified in the description hereinafter set forth, and the scope of the invention is indicated in the claims.

### BRIEF DESCRIPTION OF THE SEVERAL VIEWS OF THE DRAWING

These and other objects of the present invention will become evident from the following illustrations:

FIG. 1 is a block diagram of an exemplary system formed in accordance with the present invention.

FIG. 2 is a process performed by the system shown in FIG. I for performing the export compliance in accordance with the present invention.

FIGS. 3-14 illustrate exemplary graphical user interface windows used in the process shown in FIG. 2.

FIG. 15 is an example process performed by the system of FIG. 2 under the Report Selection providing an audit report in accordance with the present invention.

FIG. 16 is an example process performed by the system of FIG. 2 under the Report Selection providing an immigration status report on selected employees in accordance with the present invention.

FIG. 17 is an example process performed by the system of FIG. 2 under the Report Selection providing an individual employee licensing breakdown in accordance with the present invention.

### DETAILED DESCRIPTION OF THE INVENTION

In the following detailed description of sample embodiments of the invention, reference is made to the accompanying figures that form a part hereof, and that is shown by way of illustration specific sample embodiments, in which the invention may be practiced. These embodiments are described in sufficient detail to enable those skilled in the art to practice the invention, and it is to be understood that other embodiments may be utilized and that changes may be made without departing from the spirit or scope of the present invention.

The present invention relates to a visible database tracking immigration status and product access from the time of hire until termination. FIG. I illustrates the users, foreign and abroad, entering their employees into the database at the time of hire or before. The users enter their products and technology into the database, if a foreign national has access to them.

A “foreign national” is defined as a person who is not: a U.S. citizen, lawful permanent resident (“green card” holder), or a protected person (i.e., refugee). Foreign nationals would be persons temporarily in the U.S. under the following visas: H-1B, H-4, H-2B, H-2C, L-1 intra-company transferees, L-2, F-1 students, OPT optional practical training, B-1 or B-2 visitors, visa waiver program visitors, O, J, R, P and possibly other visas. Foreign workers who work at sites abroad must be listed. Immigration documentation would be stored on the web database, such as Lawful Permanent Resident Cards (“Green Cards”), Employment Authorization Documents (“EADs”), passports with visa stamps, Form I-94 (“Entry Document”), visa approval letter, and any other applicable immigration documentation.

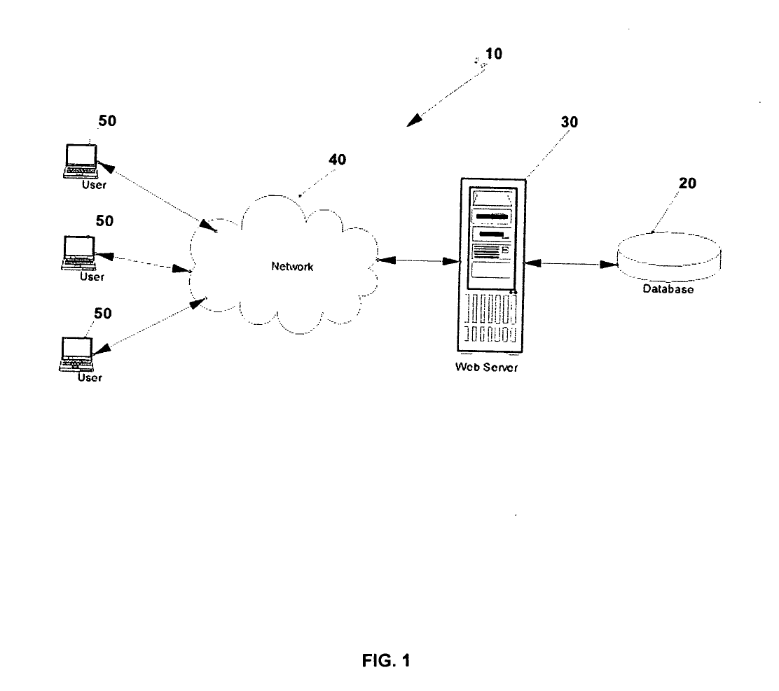

FIG. 1 illustrates an example system 10 that allows a company to efficiently and effectively track and match immigration status with product/technology transfers in compliance with export regulations under EAR and ITAR. The system 10 includes a server 30 coupled to a plurality of user systems 50 over a network 40 and the server 30 is directly coupled to a database 20. The server executes the export/immigration/technology transfer application program. The user system 50 accesses the server 30 and the export compliance application program over the network 40.

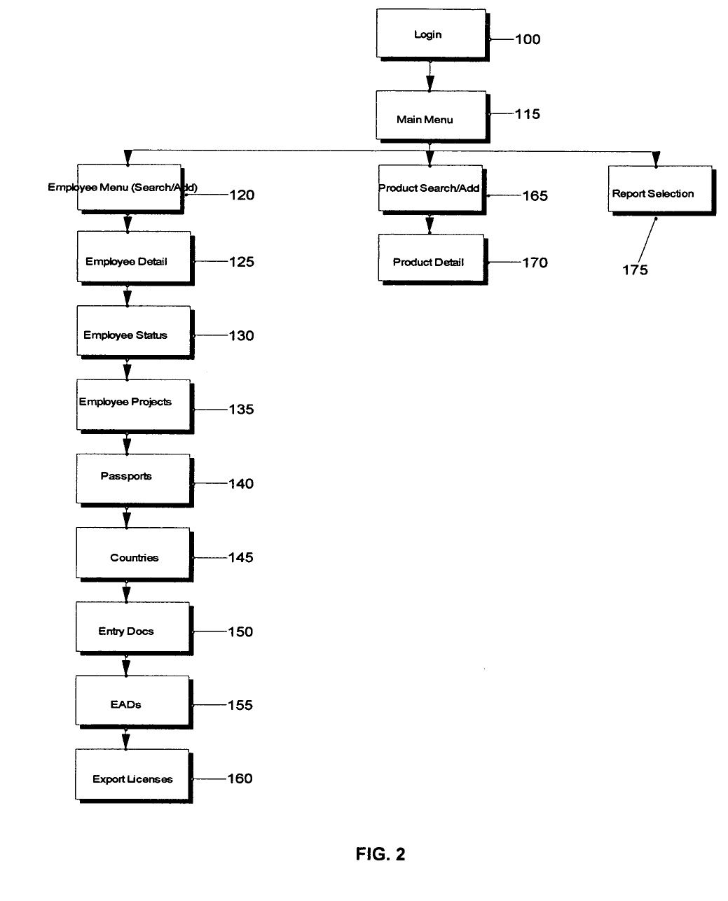

FIG. 2 illustrates the user logs 100 into the export compliance application program that is running on the server 30 of FIG. 1.

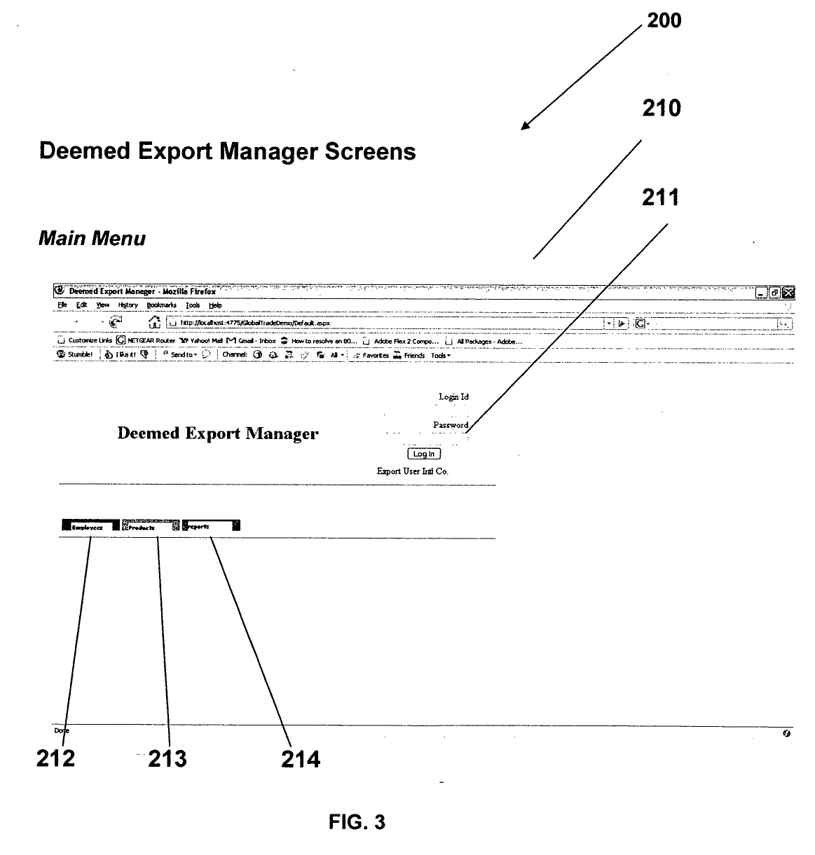

FIG. 3 illustrates a window for the Deemed Export Manager Screens, 200 (115, FIG. 2) that includes a user interface page 210 that is the “Main Menu” for the log in screen 211. The window 200 includes an information upload area that allows a user to select Employees 212, Products 213, or Reports 214.

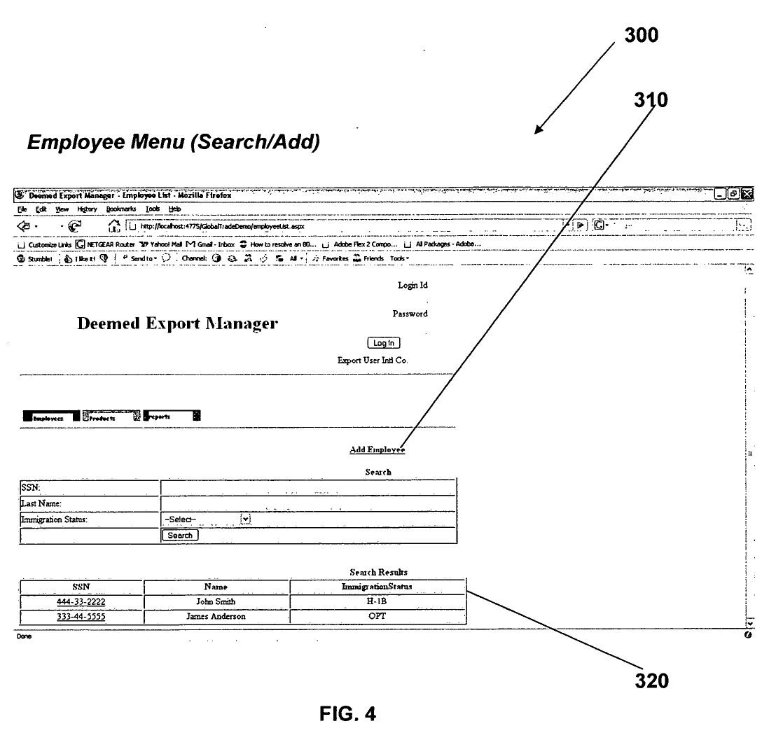

The following primary data elements are entered on the foreign national pages as illustrated in FIGS. 4-11: (1) date of termination of foreign national (if no longer employed); (2) full address abroad, if maintaining a residence abroad; (3) Form I-94 (entry document) number and date issued; (4) date the visa was issued; (5) dates in each different visa status; (6) foreign passport country and number, if more than one; (7) U.S. address; (8) a box is checked whether visitor (e.g., factory tour); (9) exact location of employment; (10) any limitations noted on employee's social security card (e.g.; “not valid without employment authorization . . . ”); (11) type of visa [H-1B, H-4, L, J, H-2A, H-2B, OPT, F-1, Permanent Resident, U.S. citizen].

FIG. 4 illustrates the “Employee Menu (Search/Add)” window 300 (120, FIG. 2) with respect to adding employees 310 by name and immigration status or searching employee name and immigration status by social security number 320.

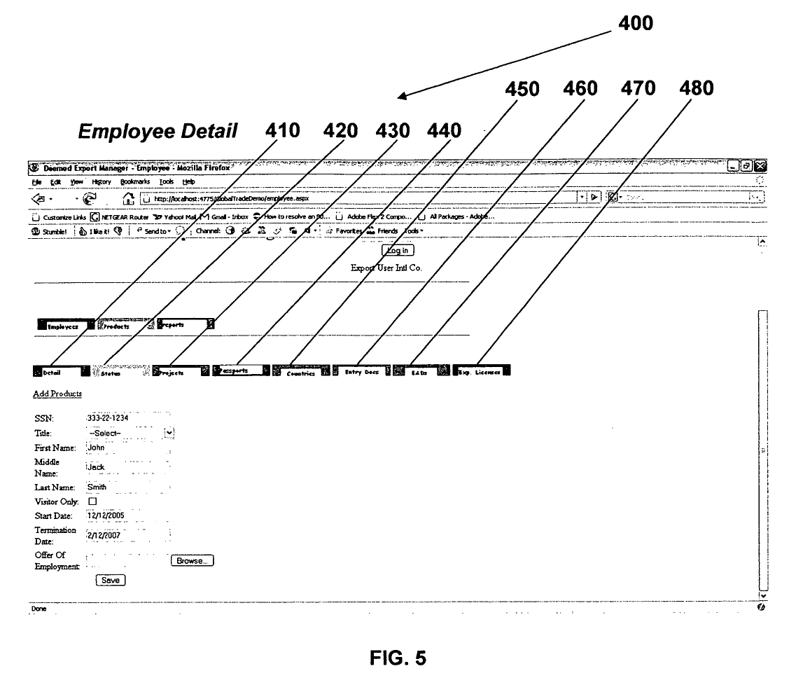

FIG. 5 illustrates the “Employee Detail” window 400 (125, FIG. 2) with inputs for name, title, SSN, start date, termination date and offers of employment and which window 400 provides tabs for Detail 410, Status 420, Projects 430, Passports 440, Countries 450, Entry Docs 460, EADs 470, and Export Licenses 480.

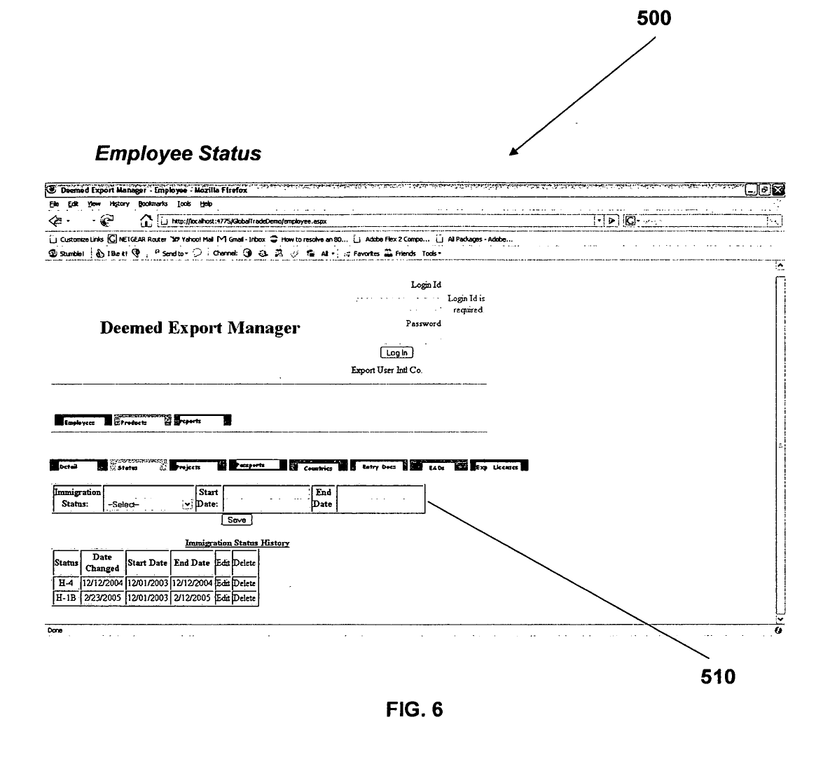

FIG. 6 illustrates the “Employee Status” window 500 (130, FIG. 2) with respect to immigration status history 510.

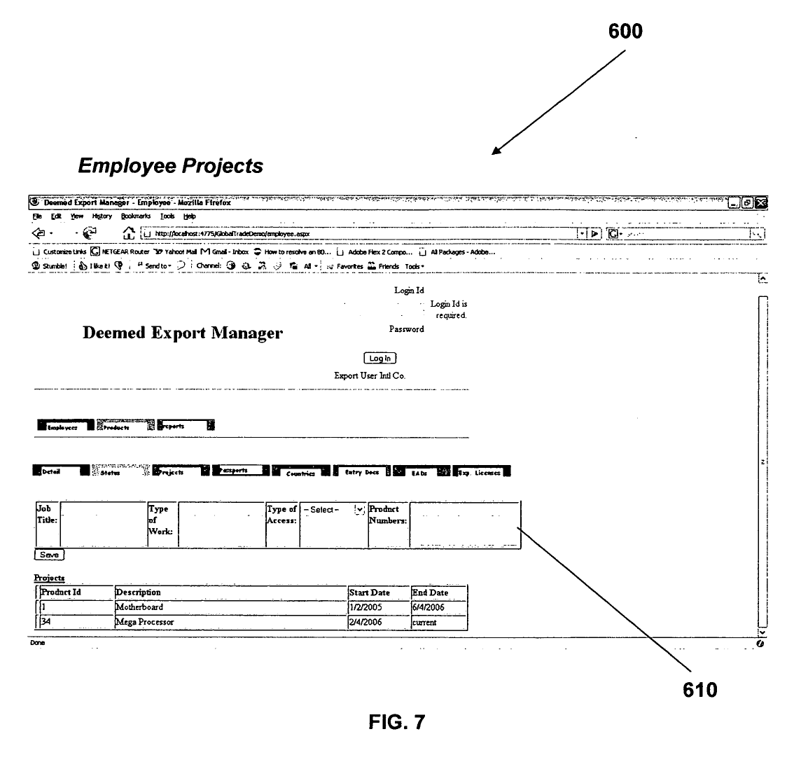

FIG. 7 illustrates the “Employee Projects” window 600 (135, FIG. 2) with inputs to job title, type of work, type of access and product numbers 610 and matching product identification, description and start and end dates.

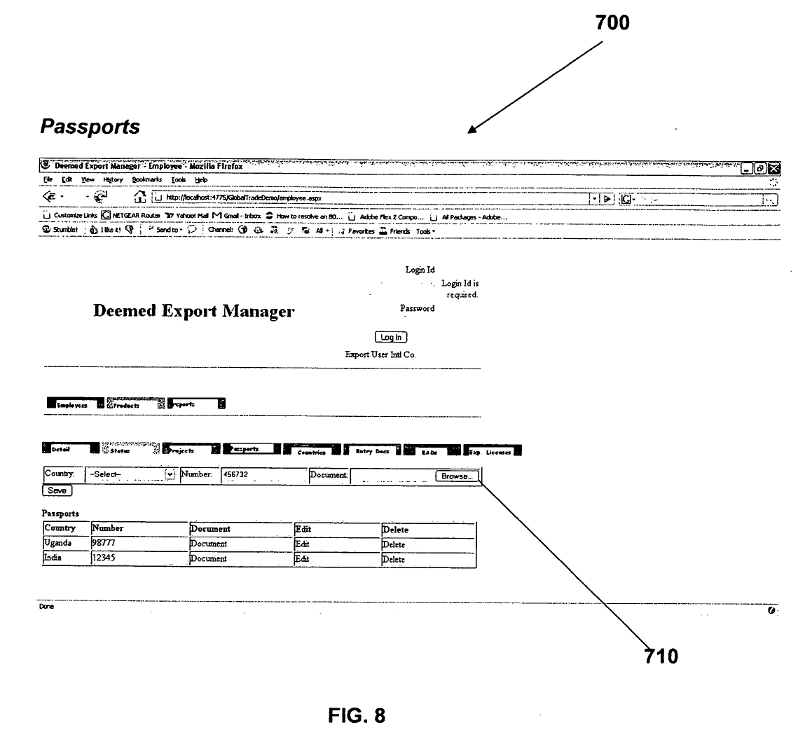

FIG. 8 illustrates the “Passports” window 700 (140, FIG. 2) with the entry of country, number and document 710.

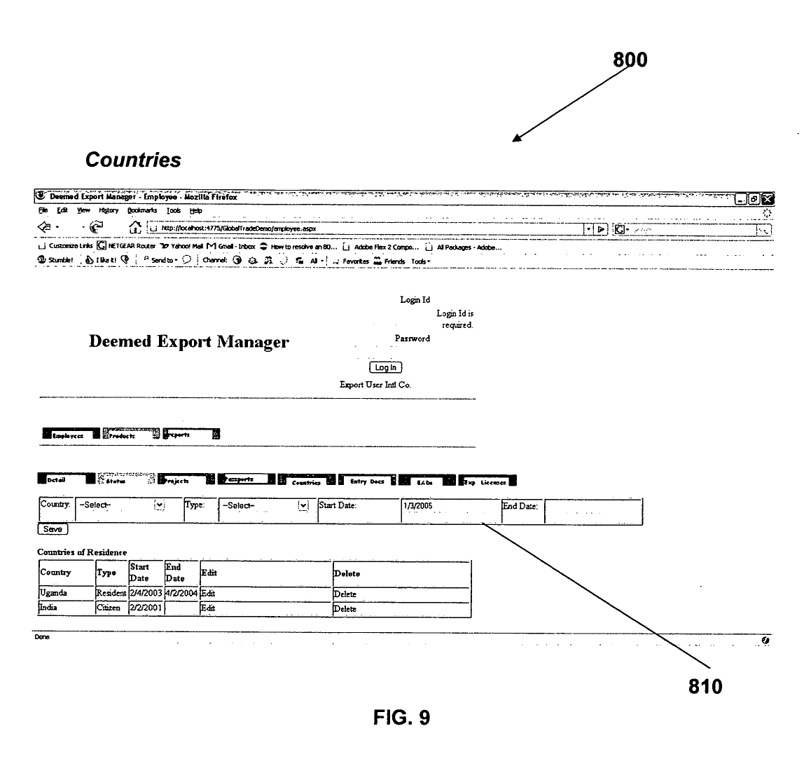

FIG. 9 illustrates the “Countries” window 800 (145, FIG. 2) with the entry of country of residence, status and start and end dates 810.

When a notification of possible non-compliance occurs, the program identifies persons who would be “foreign nationals” under the deemed export rule.

Every product would be tracked by part number and/or Export Commerce Control Number (ECCN) to which each foreign national has access and would determine the employees who need an export license under the deemed export rule. The user must enter the ECCN.

The user classifies all parts and technology to which the foreign national has access under the Commerce Control List (CCL) of the EAR.

Non-controlled items fall into the category called EAR99. If an item is EAR99, it will not normally require a license from BIS under EAR.

The user needs to know whether a product is on the U.S. Munitions List under the ITAR, whether a “defense service” is provided under the ITAR.

The data elements under the product section are as follows: (1) license status—licensed, RWA'd [returned without action], or denied; (2) if license issued, license number(s), add a “notes” section to note any restrictions on the license; (3) whether the employee has access to any U.S. government classified information; (4) the type of use of the technology the foreign national has, which ties to each product/technology access, such as development, production, design; (5) type of release of technology linked to each product/technology accessed, such as visual inspection, oral exchange, personal knowledge, technical experience, quantity of each product or technology, and value of each product or technology.

To monitor technology transfers abroad, every foreign national abroad is tracked who has access to technical data via the server or otherwise, and to which technical data having access and how it is controlled.

When an export license is required for a foreign national, immediate notification to file the required export license application results. The rules for deemed exports under EAR are different from the rules for deemed exports under ITAR. Separate notifications show which rules apply in order to file the license application with the correct agency. Under EAR, the last country of residence or citizenship applies. Under ITAR, all nationalities apply.

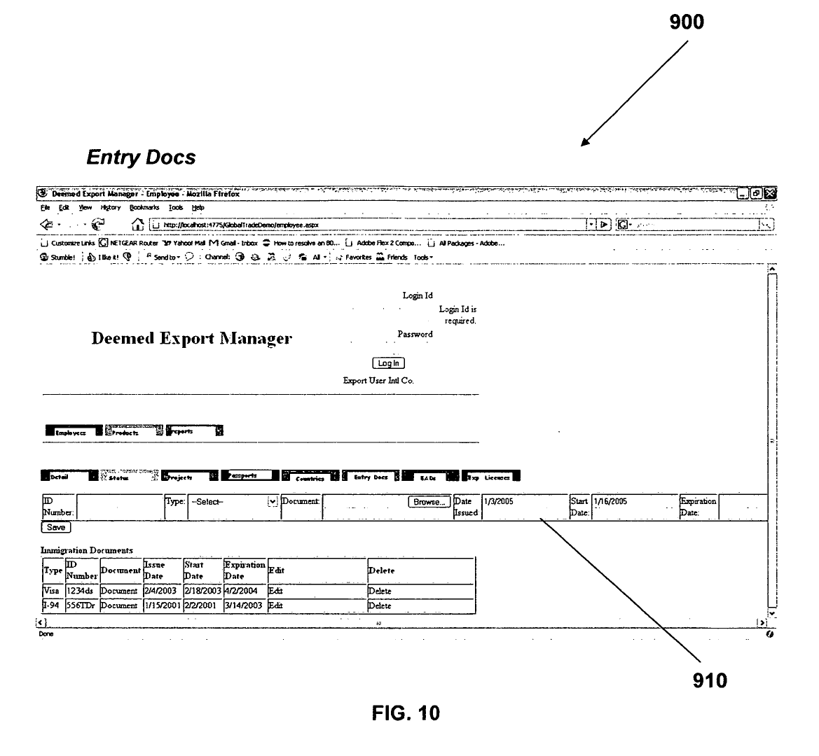

FIG. 10 illustrates the “Entry Docs” window 900 (150, FIG. 2) with the entry of type of entry immigration document, ID number, and date issued and expiration date 910.

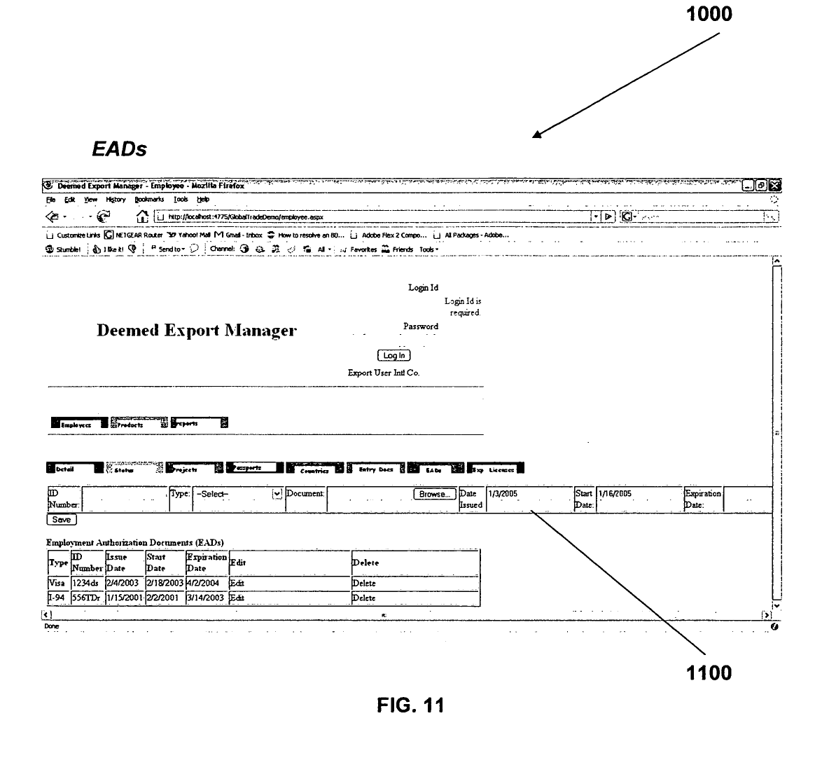

FIG. 11 illustrates the “EADs” windows 1000 (155, FIG. 2) with the entry of Employment Authorization Documents, ID number, issue date, start date and expiration date 1100.

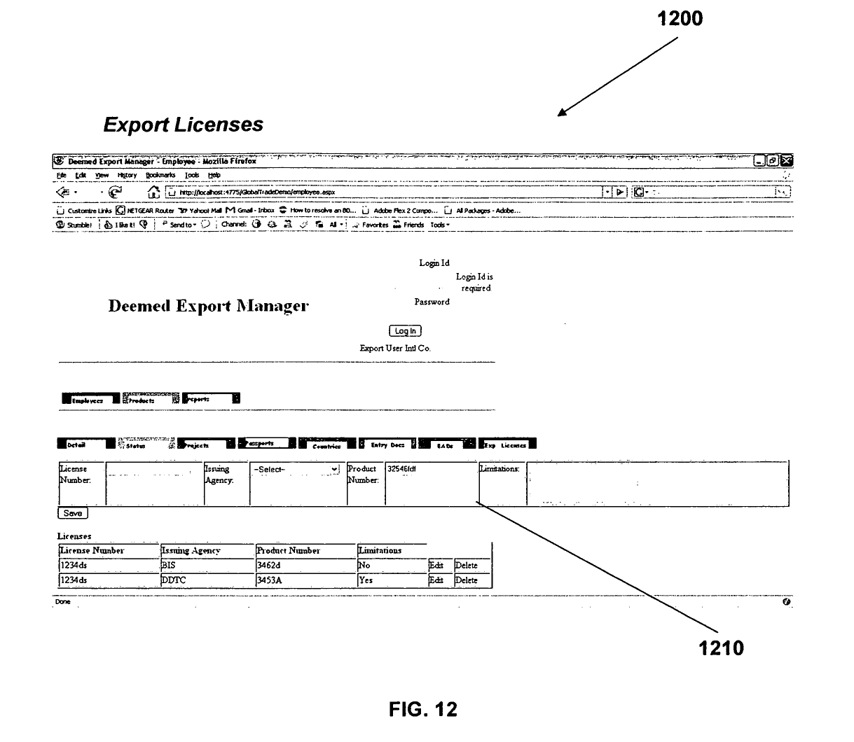

FIG. 12 illustrates the “Export Licenses” windows 1200 (160, FIG. 2) with the entry of license number, issuing agency, product number and limitations 1220.

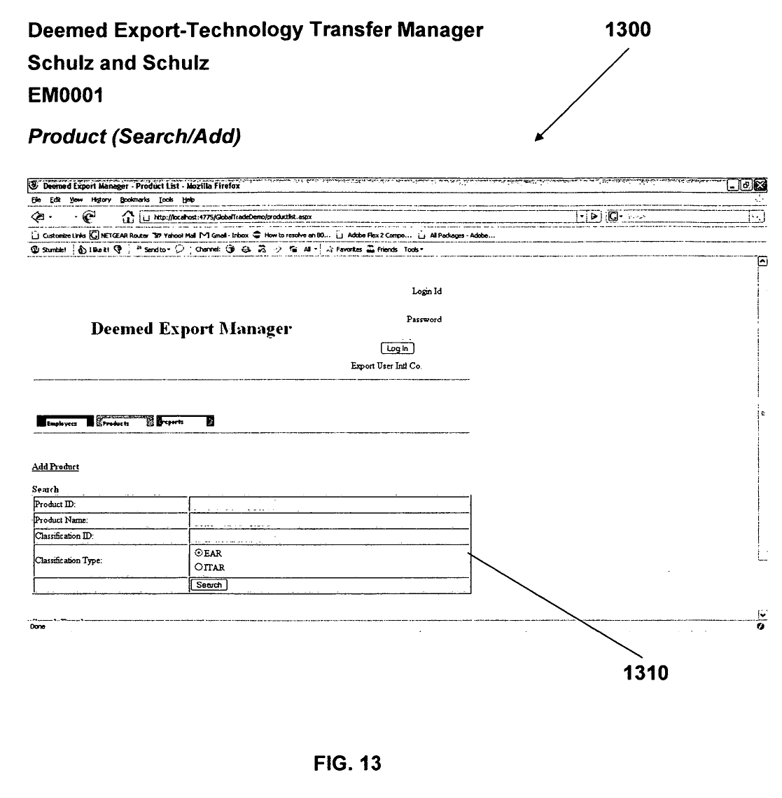

FIG. 13 illustrates the “Product (Search/Add)” windows 1300 (165, FIG. 2) with product ID. Product name, classification ID and classification type either EAR or ITAR 1330.

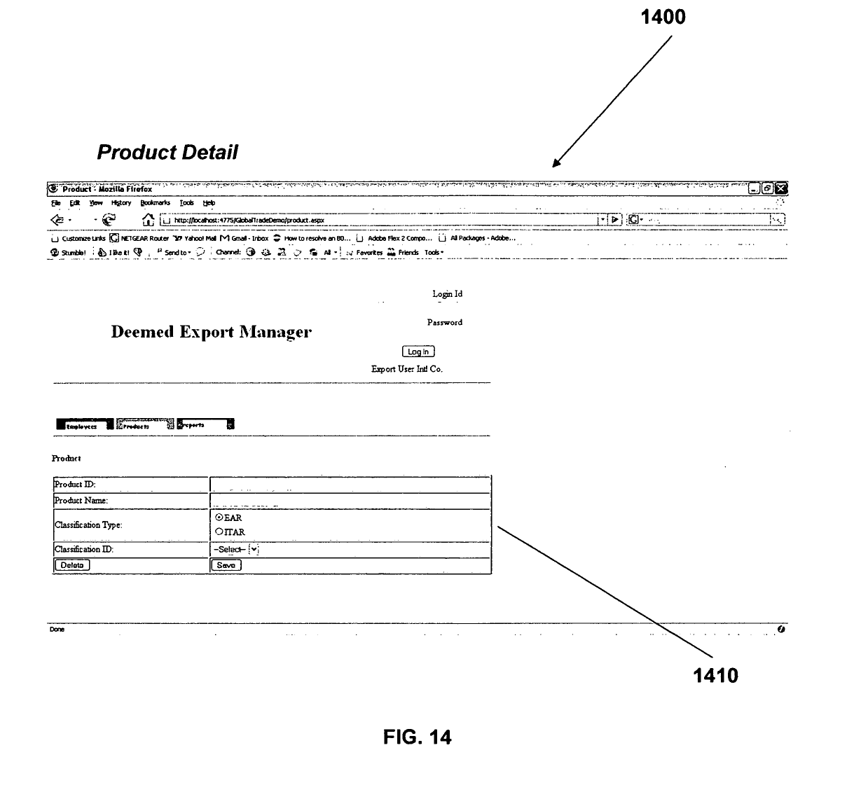

FIG. 14 illustrates the “Product Detail” windows 1400 (170, FIG. 2) with product detail box 1410.

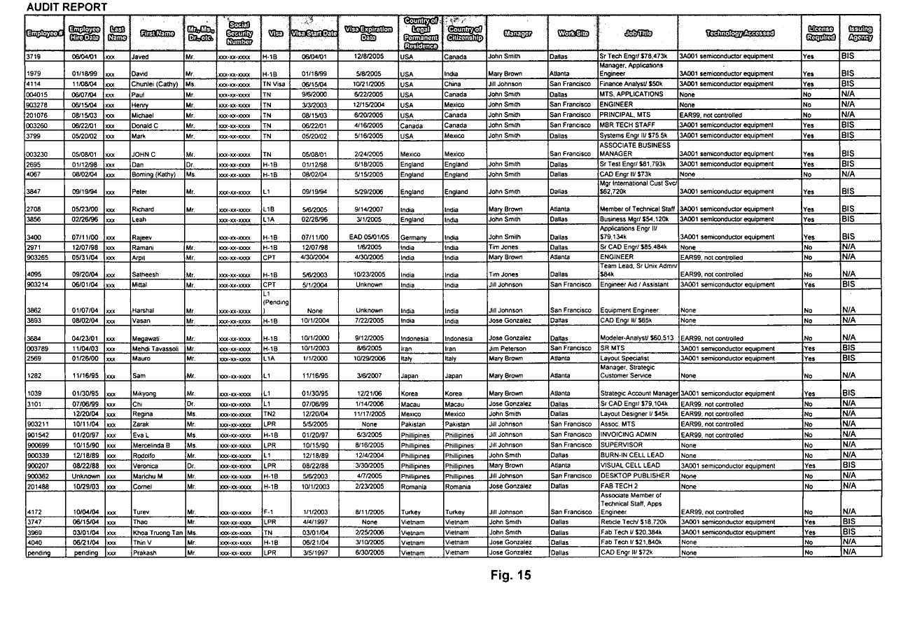

FIG. 15 illustrates under the “Report Selection” (175, FIG. 2) the Audit Report.

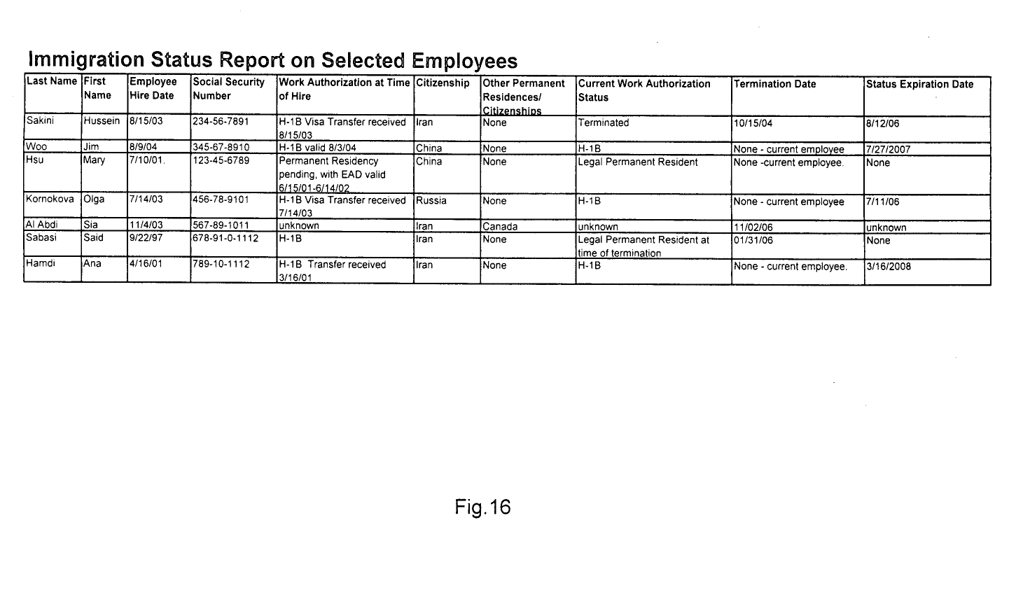

FIG. 16 illustrates under the “Report Selection” (175, FIG. 2) the Immigration Status Report on Selected Employees.

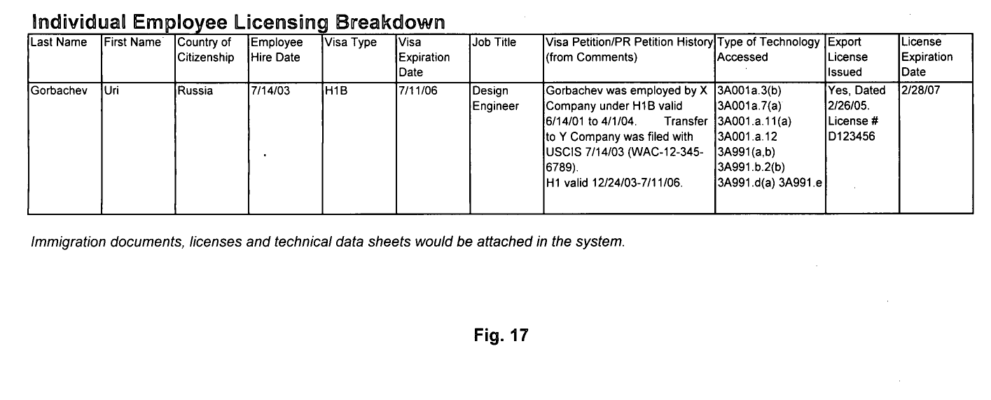

FIG. 17 illustrates under the “Report Selection” (175, FIG. 2) the Individual Employee Licensing Breakdown.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the invention. It is thus to be understood that the invention is not limited to the disclosed embodiments, but modifications and variations in the present invention may be made without departing from the novel aspects of this invention as defined in the claims. It is intended that this invention be limited only by the claims, and the full scope of equivalent arrangements included within the spirit and scope of the claims.

The invention claimed is:

1. A computer-based method for performing the tracking of immigration status and product access from the time of hire until termination under the Export Administration Regulations (EAR) and the International Traffic in Arms Regulations (ITAR), the method comprising:
submitting employee information into a database along with products and technology for compliance review;
automatically reviewing the entered employee data and product and technology information; and
automatically generating export compliance information on license analysis.

2. The method of claim 1, further comprising:
generating export compliance information pursuant to EAR and ITAR for matching employee information with product and technology to determine transfers of data or technology to a foreign national in the United States and transfers to foreign nationals abroad.

3. The method of claim 2, comprising storing the entered employee data and product and technology information for EAR and ITAR analysis.

4. The method of claim 1, notifying immediately of possible non-compliance of a person who would be a foreign national under the deemed export rule.

5. The method of claim 1, tracking every product by part number and/or Export Commerce Control Number (ECCN) to which each foreign national has access and would determine the employees, requiring an export license under the deemed export rule.

6. The method of claim 1, comprising the classification of all parts and technology to which the foreign national has access under the Commerce Control List (CCL) of the EAR.

7. The method of claim 1, determining whether a product is on the U.S. Munitions List under ITAR and whether a defense service is provided under ITAR.

8. The method of claim 1, monitoring technology transfers abroad and tracking, every foreign national abroad who has access to technical data and the technical data having access and how it is controlled.

9. The method of claim 1, indicating when an export license is required for a foreign national and the required export license application results.

10. The method of claim 3, showing separate notifications and which rules apply in order to file the license application with the correct federal agency.

11. The method of claim 4, allowing the user to generate an audit report matching all foreign employees with individual access to technology.

12. The method of claim 5, allowing the user to generate an immigration status report on selected employees.

13. The method of claim 6, allowing the user to generate an individual employee licensing breakdown, listing foreign employee with the type of technology accessed, visa information and export license information.
